(19) United States
(12) Patent Application Publication
(10) Pub. No.: US 2025/0308191 A1
(43) Pub. Date: Oct. 2, 2025

(54) TRAINING MACHINE LEARNING MODELS TO DETECT KEY POINTS IN IMAGES

(71) Applicant: Robert Bosch GmbH, Stuttgart (DE)

(72) Inventors: Annika Hagemann, Hildesheim (DE); Andre Wagner, Hannover (DE); Jan Fabian Schmid, Hamburg (DE)

(21) Appl. No.: 19/080,553

(22) Filed: Mar. 14, 2025

(30) Foreign Application Priority Data
Mar. 27, 2024 (DE) 10 2024 202 920.3

(51) Int. Cl. G06V 10/25; G06V 10/776

(52) U.S. Cl. CPC G06V 10/25; G06V 10/776

(57) ABSTRACT

A method for training a machine learning model which is configured to identify easily recognizable key points in an input image. The method includes: providing a set of training images; transforming each training image into a variation which contains contents of the training image at other positions; adding synthetically generated image contents to each training image and to its variation, which show the same semantic contents from different perspectives; ascertaining key points for the training image on the one hand and for the variation on the other, using the machine learning model; evaluating using a given cost function the extent to which corresponding key points of the training image and its variation relate to corresponding image contents; and optimizing parameters characterizing the behavior of the machine learning model, with the aim of improving the evaluation by the cost function during further processing of training images and variations.

### CROSS REFERENCE

The present application claims the benefit under 35 U.S.C. § 119 of German Patent Application No. DE 10 2024 202 920.3 filed on Mar. 27, 2024, which is expressly incorporated herein by reference in its entirety.

### FIELD

The present invention relates to the analysis of images for evaluation with regard to a given task, for example in the context of monitoring the surroundings of vehicles.

### BACKGROUND INFORMATION

For many applications, it is required to constantly observe a scene, such as the surroundings of a vehicle, and to take a large number of images. The images are not viewed individually, but information is obtained from combinations of several images. Since there is always a relative movement between the camera and the scene, especially in mobile applications, it is necessary to evaluate which points and areas in a first image correspond to which points and areas in a second image. For this purpose, machine learning models are used that identify particularly easily recognizable key points in the images.

One way to train such machine learning models without much manual effort to generate “ground truth” is to transform training images into variations using conventional transformations. When both the training images and the variations are then processed with the machine learning model, the key points of the variations should move to positions that are expected based on the transformations.

### SUMMARY

The present invention provides a method for training a machine learning model. The machine learning model is configured to identify easily recognizable key points in an input image.

Such key points can in particular be, for example, points that are characteristic of an essential content of the input image and at the same time can be clearly localized. Corners or points in particularly high-contrast regions are particularly well suited as key points, as the corner marks exactly one point. For example, points on the border between a white area and a black area are less suitable, since starting from every point on this border, the relevant local environment looks exactly the same.

A trainable machine learning model in particular refers to a model that embodies a function that is parameterized with adjustable parameters and has great power to generalize. During training, the parameters may be adapted, in particular, in such a manner, that in response to inputting input variable learning values into the model, the corresponding output variable learning values are reproduced as effectively as possible. The trainable machine learning model can in particular include an artificial neural network (ANN) and/or a support vector machine (SVM), and/or it can be an ANN or an SVM.

A set of training images is provided within the scope of the present invention. Each training image is transformed into a variation that contains contents of the training image at other positions.

According to an example embodiment of the present invention, synthetically generated image contents are then added to each training image on the one hand and its variation on the other. These synthetically generated image contents show the same semantic contents from different perspectives. For example, synthetically generated images of one or more objects can be used for this purpose.

According to an example embodiment of the present invention, using the machine learning model, key points are ascertained for the training image modified in such a way on the one hand and for the variation modified in such a way on the other. In particular, this can be understood for example to mean that the machine learning model assigns scalar values to pixels or other parts of the relevant image and then uses these scalar values to determine the distinguished key points. However, the machine learning model can also be configured, for example, to provide the key points directly as outputs.

According to an example embodiment of the present invention, a given cost function (loss function) is used to evaluate the extent to which corresponding key points of the training image and its variation relate to corresponding image contents. Parameters that characterize the behavior of the machine learning model are optimized with the aim of improving the evaluation by the cost function during further processing of training images and variations.

It was found that adding synthetically generated image contents results in the semantic contents of the training image and of the variation differing from each other. The transformation of the training image into the variation as such ensures that the contents of the training image can be found in other places in the variation. However, the depicted scene itself and the perspective from which this scene is depicted are not changed. This means that only the appearance of the scene is changed, without anything being added to or omitted from the scene itself. Often, the vast majority of the contents of the training image have a counterpart in the variation. Thus, nothing is added or omitted from the variation as a result of the transformation. The synthetically generated image content in the training image on the other hand shows something that the variation and its synthetically generated image content do not show. In particular, in the variation, for example, the synthetically generated image contents can be shown in a different position or from a different perspective, and/or synthetic image contents can be omitted altogether or in part. In particular, a real change of perspective could only be partially simulated using conventional transformations. However, the recognition of objects and key points from different perspectives is particularly important for applications in which a three-dimensional representation of an environment is to be created from several two-dimensional camera images.

Furthermore, according to an example embodiment of the present invention, the synthetically generated image contents can also be used to simulate, for example, that a certain object is moving while the rest of the scene shown in the image remains unchanged. Points that belong to such moving image contents are usually particularly difficult to recognize. By synthetically adding moving objects, such as vehicles, at different locations, the model can learn that key points on these objects are less stable and therefore less suitable for certain applications (e.g., mapping and localization). In particular, the key points on these objects are, for example, not temporally stable, i.e., they cannot necessarily be found again at the same location at a later point in time.

Ultimately, the improved training results in the machine learning model being able to better ascertain key points from input images that are more suitable for recognition. If these key points are now recognized in a sequence of many images using the machine learning model, the merging of information from these many images is improved. For example, the accuracy of a three-dimensional environment representation, which is developed from many two-dimensional views, is improved by combining only such information that actually refers to the same locations in the images.

In a particularly advantageous embodiment of the present invention, the variation includes a homographic mapping of the training image. A homographic mapping in the space of two-dimensional shapes is a collineation of the two-dimensional real projective space onto itself. Such a collineation is a bijective mapping in which every straight line is mapped to a straight line. In particular, points that lie in a straight line in the training image are still in a straight line in the variation. A homographic mapping thus completely preserves the content of the training image that needs to be recognized.

Homographic mapping can in particular comprise, for example, a scaling, a rotation, an enlargement, a reduction, a translation and/or a distortion. A distortion implies that lines that were previously the same length are no longer the same length afterwards.

In another particularly advantageous embodiment of the present invention, the synthetically generated image contents are added in such a way that each pixel of the resulting image is significantly determined either by the training image or its variation or by the synthetically generated image contents. In this way, correspondences between locations in the training image on the one hand and in the variation on the other can be ascertained particularly easily. If a pixel belongs to the original content of the training image, the location where its counterpart can be found in the variation is determined by the transformation used to create the variation. If, on the other hand, a pixel belongs to the synthetically generated image content, the location where its counterpart can be found in the variation is given by the rule according to which the relevant synthetic image contents were used in the training image on the one hand and in the variation on the other. There does not have to be a counterpart in the synthetically generated image content in the variation for every piece of information of the synthetically generated image content in the training image. Rather, for example, information that is visible in the perspective chosen for the synthetically generated image contents of the training image may be obscured in the perspective chosen for the synthetically generated image contents of the variation.

Adding the synthetic image content to the training image or to the variation can be done, for example, by superposition, but also in any more complex way. In particular it can be determined, for example, to what extent synthetic image content is obscured by original contents of the training image or of the variation, and vice versa.

In another particularly advantageous embodiment of the present invention, a two-dimensional rendering of a view of at least one three-dimensional object from a given perspective is selected as synthetically generated image content. In this way, adding the synthetically generated image contents can be controlled in such a way that these synthetically generated image contents appear realistic in the context of the original training image or original variation. This results in improved key point detection in the domain of realistic images. If the machine learning model is trained on a domain that does not have much to do with realistic images, there is no guarantee that ascertaining key points will generalize well to processing realistic images in later real-world operation.

The different perspectives of the synthetically generated image contents for the training image on the one hand and for the variation on the other can be selected in particular, for example, such that at least a partial area of a three-dimensional object can be viewed from both perspectives. The machine learning model can then be trained in particular to recognize contents that can be viewed from multiple perspectives. As explained above, this is the intended use of the key points to be identified. In general, the training image and the variation, as well as the versions enriched with synthetically generated image contents, can be viewed as two-dimensional sets of points, wherein each individual point corresponds to a point in three-dimensional space. Points in the training image or in the variation can correspond to one and the same point in three-dimensional space. These points can then be considered as corresponding to each other.

In another particularly advantageous embodiment of the present invention, the synthetic image contents added to the variation are changed in at least one stylistic aspect compared to the synthetic image contents added to the training image. In this way, the machine learning model can be trained to recognize certain features, for example, even if they come in a new stylistic guise. The machine learning model can thus learn that style is not the deciding factor, but that content concealed in style is what matters.

For example, the stylistic change can include a change in the texture of at least one object, and/or a change in an influence of the time of day, season and/or weather conditions on at least one object in the synthetic image contents. For example, a tree can be used once in a leafless state and once in a leafy state. Changes of this kind are relevant in particular when using the machine learning model for the environmental monitoring of vehicles or robots. Here it is important that, for example, the semantic interpretation of a traffic situation does not depend on stylistic aspects that have nothing to do with the semantic content. For example, a set of training examples may contain certain rarely occurring traffic situations only in combination with certain times of day or seasons. Nevertheless, it is expected that the relevant traffic situation will be treated and resolved in the same way at other times of day and seasons, because traffic rules are valid 24/7 and all year round.

In another sample application from the mapping and localization area, an environment may have been mapped in summer during daylight hours and so the map contains image information from summer. Now, if you want to locate yourself within this map in winter, you have to find correspondences between the summer map and the current winter images. The key points must therefore be robust against seasonal and time-of-day changes.

In another particularly advantageous embodiment of the present invention, the synthetic image contents are selected and/or added such as to be consistent with the ground plane and the direction of the gravitational force that are valid in the context of the relevant training image or variation. In this way, the combination of the training image or variation and the relevant synthetically generated image content is more realistic. This reduces the domain shift between the domain of the training images and variations modified by the use of synthetic image contents on the one hand and the real images later processed by the trained machine learning model on the other. This increases the probability that the machine learning model trained with the modified training images and modified variations will generalize well to the real images.

In another particularly advantageous embodiment of the present invention, at least one synthetically generated image content is created with a diffusion model. In particular, a diffusion model can be configured, for example, to generate the synthetically generated image content from input noise in successive iterations. The noise can thus be “inverted” further and further from iteration to iteration. The generation of the image content can be conditioned with any specifications, such as a textual description of the image content (also referred to as “prompt”). In this way, it is possible to create particularly realistic-looking synthetically generated image contents. In particular, for example,
the appearance of the associated 3D objects can be designed realistically, and/or
the style of the synthetic image contents can be adapted to the scene, and/or
a 3D model can be generated directly from objects contained in the training data set and stylistically modified.

In another particularly advantageous embodiment of the present invention, the machine learning model is configured to provide, in addition to the key points, descriptors that characterize the environment of the relevant key point in the relevant image. Evaluation by the cost function then includes a comparison of descriptors of the training image on the one hand and of the variation on the other. In this way, it can be taken into account that different key points can refer to different types of features to be recognized. For example, a corner to which the key point refers can be specifically highlighted instead of assigning each key point an environment “patch” that always looks the same.

In another particularly advantageous embodiment of the present invention, the machine learning model is configured to give each pixel of an input image a score that measures said pixel's suitability as a key point. Pixels with the highest values of this score can then be selected as key points. In this way, the output of the machine learning model can always have the same dimensionality (size), regardless of how many key points are found in the image. The same applies to the output of descriptors. They can be provided for every pixel in the image, and not just those pixels that will ultimately become key points.

In another particularly advantageous embodiment of the present invention, the trained machine learning model is fed with input images that were recorded with at least one sensor. At least one control signal is ascertained using the key points of the input images ascertained by the trained machine learning model. In particular, this can include, for example, using the recognition of key points ascertained in a first input image for further input images. A vehicle, a driver assistance system, a robot, a system for quality control, a system for monitoring areas, and/or a system for medical imaging is controlled with the control signal. Due to the better training of the machine learning model, the probability is increased that the reaction of the technical system controlled in each case to the control signal of the situation embodied in the input images is appropriate.

In particular, according to an example embodiment of the present invention, when ascertaining the control signal, for example, one or more additional machine learning models can be used. For example, types of objects in the environment, or even a traffic situation prevailing in the environment as a whole, can be classified based on the key points and a representation of the environment of a vehicle or robot ascertained from many input images by means of the key points. The result obtained can then be used to plan a future trajectory of the vehicle or robot using another machine learning model.

Thus, using the key points can in particular include, for example, using the key points
to determine a position of a vehicle or robot,
to construct a three-dimensional model of an area or environment, and/or
to create a map of an environment in which a vehicle or robot moves.

According to an example embodiment of the present invention, the method can in particular be wholly or partially computer-implemented. The present invention therefore also relates to a computer program comprising machine-readable instructions that, when executed on one or more computers and/or compute instances, cause the computer(s) and/or compute instances to execute the described method. In this sense, control devices for vehicles and embedded systems for technical devices, which are also capable of executing machine-readable instructions, are also to be regarded as computers. Compute instances can be virtual machines, containers or serverless execution environments, for example, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to the figures.

### BRIEF DESCRIPTION OF THE DRAWINGS

FIG. 1 shows an exemplary embodiment of the method 100 for training a machine learning model 1, according to the present invention.

FIG. 2 shows exemplary key points 3a, 3b in an exemplary training image 2a with a variation 2b, which are enriched with exemplary synthetically generated image contents 4a, 4b, according to an example embodiment of the present invention.

### DETAILED DESCRIPTION OF EXAMPLE EMBODIMENTS

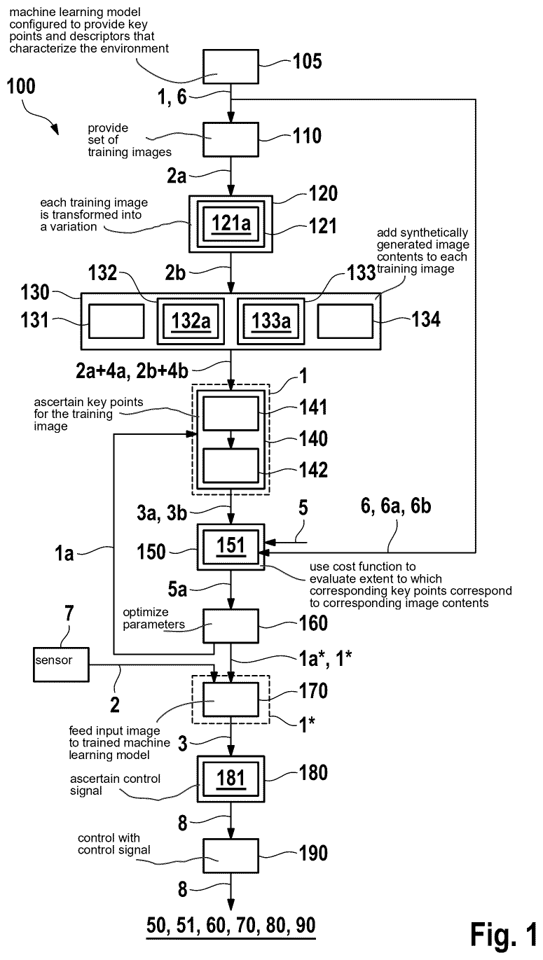

FIG. 1 is a schematic flow chart of an exemplary embodiment of the method 100 for training a machine learning model 1. The machine learning model 1 is configured to identify easily recognizable key points 3 in an input image 2.

According to block 105, the machine learning model 1 can be configured to provide, in addition to the key points 3, descriptors 6 that characterize the environment of the relevant key point 3 in the relevant image 2.

In step 110, a set of training images 2a is provided.

In step 120, each training image 2a is transformed into a variation 2b that contains contents of the training image 2a at other positions.

According to block 121, this variation 2b can include a homographic mapping of the training image 2a.

According to block 121a, the homographic mapping can in particular comprise, for example, a scaling, a rotation, an enlargement, a reduction, a translation and/or a distortion.

In step 130, synthetically generated image contents 4a, 4b are added to each training image 2a on the one hand and its variation 2b on the other, which show the same semantic contents from different perspectives. The result is a training image 2a+4a enriched with the synthetically generated image content 4a and a variation 2b+4b enriched with the synthetically generated image content 4b. These enriched versions 2a+4a or 2b+4b replace the original training image 2a or the original variation 2b during further processing.

According to block 131, the synthetically generated image contents 4a, 4b can be added in such a way that each pixel of the resulting image 2a+4a; 2b+4b is significantly determined either by the training image 2a or its variation 2b or by the synthetically generated image contents 4a, 4b.

According to block 132, a two-dimensional rendering of a view of at least one three-dimensional object from a given perspective can be selected as synthetically generated image content 4a, 4b.

According to block 132a, the different perspectives of the synthetically generated image contents 4a, 4b for the training image 2a on the one hand and for the variation 2b on the other can be selected such that at least a partial area of a three-dimensional object can be viewed from both perspectives.

According to block 133, the synthetic image contents 4b added to the variation 2b can be changed in at least one stylistic aspect compared to the synthetic image contents 4a added to the training image 2a.

According to block 133a, this stylistic change can in particular comprise, for example, a change in the texture of at least one object, and/or a change in an influence of the time of day, season and/or weather conditions on at least one object in the synthetic image contents 4a, 4b.

According to block 134, the synthetic image contents 4a, 4b can be selected and/or added such as to be consistent with the ground plane and the direction of the gravitational force that are valid in the context of the relevant training image 2a or variation 2b.

In step 140, key points 3a, 3b are ascertained for the training image 2a+4a on the one hand and for the variation 2b+4b on the other using the machine learning model 1.

According to block 141, the machine learning model 1 can be configured to give each pixel of an input image 2 a score that measures said pixel's suitability as a key point 3. According to block 142, pixels with the highest values of this score can then be selected as key points 3.

In step 150, a given cost function 5 is used to evaluate the extent to which corresponding key points 3a, 3b of the training image 2a+4a enriched with the synthetically generated image contents 4a and its variation 2b+4b enriched with the synthetically generated image contents 4b relate to corresponding image contents. An evaluation 5a is created.

Insofar as the machine learning model 1 also ascertains descriptors 6 according to block 105, the evaluation by the cost function 5 can, according to block 151, include a comparison of descriptors 6a, 6b of the training image 2a+4a enriched with the synthetically generated image contents 4a on the one hand and the variation 2b+4b enriched with the synthetically generated image contents 4b on the other.

In step 160, parameters 1a characterizing the behavior of the machine learning model 1 are optimized with the aim of improving the evaluation 5a by the cost function 5 during further processing of training images 2a+4a and variations 2b+4b. The fully optimized state of the parameters 1a is denoted by reference sign 1a* and defines the trained state 1* of the machine learning model 1.

In the example shown in FIG. 1, (in step 170) the trained machine learning model 1* is fed with input images 2 that were recorded with at least one sensor 7.

In step 180, at least one control signal 8 is ascertained using the key points 3 of the input images 2 ascertained by the trained machine learning model 1*.

According to block 181, using the key points 3 can in particular include, for example, using the key points 3
to determine a position of a vehicle 50 or robot 60,
to construct a three-dimensional model of an area or environment, and/or
to create a map of an environment in which a vehicle 50 or robot 60 moves.

In step 190, a vehicle 50, a driver assistance system 51, a robot 60, a system 70 for quality control, a system 80 for monitoring areas, and/or a system 90 for medical imaging is controlled with the control signal 8.

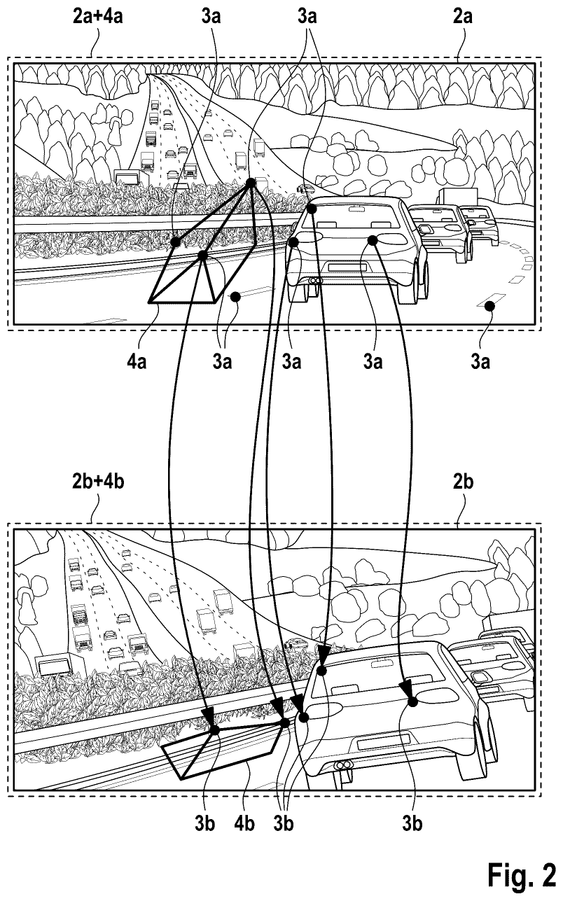

FIG. 2 illustrates the formation of a variation 2b, the enrichment with synthetically generated image contents 4a and 4b as well as the ascertainment of key points 3a, 3b using an example.

In the example shown in FIG. 2, the training image 2a shows a traffic situation. The variation 2b is a homography of the training image 2a, which shows a rotated detail and zoomed detail of the traffic situation shown in the training image 2a.

The training image 2a is enriched with a first three-dimensional view of a triangular cylinder as synthetically generated image content 4a. In this view, one end face and two of the three faces of the lateral surface of the triangular cylinder are visible.

The variation 2b, on the other hand, is enriched with a second three-dimensional view of the triangular cylinder as synthetically generated image content 4b. In this view, in addition to the end face visible in content 4a, only one of the faces of the lateral surface visible there is still visible. The second face is obscured.

Exemplary key points 3a of the enriched training image 2a+4a can be found at corners of the triangular cylinder, at high-contrast locations of one of the vehicles in the traffic situation shown in training image 2a, and at high-contrast corners where lane markings border the roadway. The same also applies to key points 3b of the enriched variation 2b+4b.

Most of the key points 3a of the enriched training image 2a+4a have counterparts in key points 3b of the enriched variation 2b+4b. One key point 3a on the triangular cylinder has no such counterpart because it is obscured in the perspective of the synthetically generated image content 4b. Some key points 3a on road markings have no counterpart in the enriched variation 2b+4b only because the homographically generated variation 2b was cropped to the size of the training image 2a. Such cropping no longer belongs to the homographic mapping, which in itself contains all the contents of the training image 2a. Otherwise the homographic mapping would no longer be bijective. However, cropping is part of the overall “homography+cropping” transformation. It is necessary for the variation to have the appropriate dimensionality to be processed by the machine learning model in the same way as the original training image.

What is claimed is:

1. A method for training a machine learning model which is configured to identify recognizable key points in an input image, the method comprising the following steps:
providing a set of training images;
transforming each training image of the set of training images into a respective variation that contains contents of the training image at other positions;
adding synthetically generated image contents to each training image on the one hand and the respectve variation on the other, which show the same semantic contents from different perspectives;
ascertaining key points for each training image on the one hand and for the respective variation on the other, using the machine learning model;
evaluating, using a given cost function, an extent to which corresponding key points of each training image and the respective variation relate to corresponding image contents; and
optimizing parameters characterizing the behavior of the machine learning model, with an aim of improving the evaluation by the cost function during further processing of training images and variations.

2. The method according to claim 1, wherein the respective variation includes a homographic mapping of the training image.

3. The method according to claim 2, wherein the homographic mapping includes a scaling, and/or a rotation, and/or an enlargement, and/or a reduction, and/or a translation and/or a distortion.

4. The method according to claim 1, wherein the synthetically generated image contents are added in such a way that each pixel of a resulting image is significantly determined either by the training image or the respective variation or by the synthetically generated image contents.

5. The method according to claim 1, wherein a two-dimensional rendering of a view of at least one three-dimensional object from a given perspective is selected as synthetically generated image content.

6. The method according to claim 5, wherein different perspectives of the synthetically generated image contents for the training image on the one hand and for the respective variation on the other are selected such that at least a partial area of a three-dimensional object can be viewed from both perspectives.

7. The method according to claim 1, wherein the synthetic image contents added to the respective variation are changed in at least one stylistic aspect compared to the synthetic image contents added to the training image.

8. The method according to claim 7, wherein the stylistic change includes: (i) a change in the texture of at least one object, and/or (ii) a change in an influence of a time of day, and/or season and/or weather conditions on at least one object in the synthetic image contents.

9. The method according to claim 1, wherein the synthetic image contents are selected and/or added such as to be consistent with a ground plane and a direction of gravitational force that are valid in the context of the training image or the respective variation.

10. The method according to claim 1, wherein:
the machine learning model is configured to provide, in addition to the key points, descriptors that characterize the environment of a relevant key point in a relevant image, and the evaluation by the cost function includes a comparison of descriptors of the training image on the one hand and of the respective variation on the other.

11. The method according to claim 1, wherein:
the machine learning model is configured to give each pixel of an input image a score that measures suitability of the pixel as a key point; and
pixels with highest values of the score are selected as the key points.

12. The method according to claim 1, wherein:
the trained machine learning model is fed with input images that were recorded with at least one sensor;
at least one control signal is ascertained using key points of the input images ascertained by the trained machine learning model, and
a vehicle and/or a driver assistance system and/or a robot and/or a system for quality control and/or a system for monitoring areas and/or a system for medical imaging, is controlled with the control signal.

13. The method according to claim 12, wherein using the key points includes using the key points:
to determine a position of a vehicle or robot,
to construct a three-dimensional model of an area or environment, and/or
to create a map of an environment in which a vehicle (or robot moves.

14. The method according to claim 1, wherein at least one synthetically generated image content is generated with a diffusion model.

15. A non-transitory machine-readable data carrier on which is stored a computer program for training a machine learning model which is configured to identify recognizable key points in an input image, the computer program, when executed by one or more computers and/or compute instances, cause the one or more computers and/or compute instances to perform the following steps:
providing a set of training images;
transforming each training image of the set of training images into a respective variation that contains contents of the training image at other positions;
adding synthetically generated image contents to each training image on the one hand and the respectve variation on the other, which show the same semantic contents from different perspectives;
ascertaining key points for each training image on the one hand and for the respective variation on the other, using the machine learning model;
evaluating, using a given cost function, an extent to which corresponding key points of each training image and the respective variation relate to corresponding image contents; and
optimizing parameters characterizing the behavior of the machine learning model, with an aim of improving the evaluation by the cost function during further processing of training images and variations.

16. One or more computers and/or compute instances comprising a non-transitory machine-readable data carrier on which is stored a computer program for training a machine learning model which is configured to identify recognizable key points in an input image, the computer program, when executed by the one or more computers and/or compute instances, cause the one or more computers and/or compute instances to perform the following steps:
providing a set of training images;
transforming each training image of the set of training images into a respective variation that contains contents of the training image at other positions;
adding synthetically generated image contents to each training image on the one hand and the respectve variation on the other, which show the same semantic contents from different perspectives;
ascertaining key points for each training image on the one hand and for the respective variation on the other, using the machine learning model;
evaluating, using a given cost function, an extent to which corresponding key points of each training image and the respective variation relate to corresponding image contents; and
optimizing parameters characterizing the behavior of the machine learning model, with an aim of improving the evaluation by the cost function during further processing of training images and variations.
